(19) United States
(12) Patent Application Publication
(10) Pub. No.: US 2005/0216938 A1
(43) Pub. Date: Sep. 29, 2005

(54) In-flight entertainment system with wireless communication among components

(75) Inventors: Kenneth A. Brady JR., Trabuco Canyon, CA (US); David Reichert, Orange, CA (US)

Correspondence Address: GARDNER CARTON & DOUGLAS LLP;ATTN: PATENT DOCKET DEPT., 191 N. WACKER DRIVE, SUITE 3700, CHICAGO, IL, 60606, US

(73) Assignee: Thales Avionics, Inc., Irvine, CA (US)

(21) Appl. No.: 11/138,170

(22) Filed: May 26, 2005

Related U.S. Application Data
(63) Continuation-in-part of application No. 10/145,464, filed on May 14, 2002.
(60) Provisional application No. 60/574,873, filed on May 27, 2004.

(51) Int. Cl. H04N 7/18; H04N 7/16

(52) U.S. Cl. 725/76; 725/75; 725/28

(57) ABSTRACT

An in-flight entertainment (IFE) system includes a network having at least one wireless router for communicating wirelessly between a network server and one or more video display unit (VDU) in the cabin. The wireless transmission of video signals provides a reduced architecture that avoids a need for cables to carry a signal to the VDU's. In an embodiment, the IFE system further facilitates the use of a remote wireless device, such as a laptop computer, as the VDU. Clients may select from a variety of programs which can be distributed in an on-demand or broadcast manner. Encryption means are further provided to enable control over content distribution to only authorized devices.

### CROSS-REFERENCE TO RELATED PATENT APPLICATIONS

This patent application is a continuation-in-part of U.S. patent application Ser. No. 10/145,464, pending, and further claims the benefit of U.S. Provisional Patent Application No. 60/574,873 filed May 27, 2004.

### BACKGROUND

The present invention is generally directed toward wireless communication over a network, and, more particularly, to a reduced-architecture in-flight entertainment (IFE) system providing wireless connectivity.

Many commercial aircraft today are equipped with an IFE system. In-flight entertainment systems are known for providing audio and/or video presentations and other services to passengers on board an aircraft.

A known type of IFE system generally comprises a reduced-architecture network of computer components, including one or more server units, processor units, input devices, and display devices installed throughout the aircraft. Such an IFE system can be configured to utilize network commands to perform traditional passenger functions, such actuation of audio volume control, reading lights, and flight attendant call indicator. Some IFE systems offer additional functionality such as individual passenger video displays and a variety of entertainment offerings.

Conventional IFE systems include a plurality of display units mounted for passenger viewing. Display units are commonly mounted in seat backs, facing the passengers in the row behind. Display units may also be mounted overhead or on seat arms. A cable to carry a video signal extends to the display unit from a port on the IFE, and wiring is also provided to deliver power to the display unit.

Weight minimization is a priority for aircraft components. Known reduced-architecture IFE systems have allowed a weight savings over earlier systems by providing an onboard network backbone to carry signals previously communicated over a plurality of cables to respective individual components. Further weight reduction remains desirable in view of the constant effort to improve aircraft performance and efficiency. A need exists for an IFE system that can provide improved performance and lower the cost of use, manufacture, and/or installation.

### SUMMARY

The present invention provides an IFE system that includes display devices equipped to receive a signal via a wireless data transmission. The display devices are mounted for viewing by passengers, such as to seat backs or arm rests. The wireless configuration eliminates a need for a cable to deliver the signal to the display from the network backbone, advantageously providing a weight savings. Moreover, the eliminated wiring results in easier installation.

The signal transmitted wirelessly to the IFE display contains at least video data. In an embodiment, the IFE display is further equipped with an audio player, in which case the signal contains audio or combined audio/video data. In an embodiment, the IFE system is provided with a server that stores and dispenses files of audio and/or video entertainment offerings.

According to an aspect of the invention, in order to prevent unauthorized use of the wireless IFE signal, the IFE system utilizes an encryption system. The transmitted signal is in a securely encoded, non-standard format. Authorized playback devices are provided with a decryption means, thereby facilitating proper playing of the wireless signal at the device. Without the decryption means, unauthorized devices would not be able to play the signal. In an embodiment, the decryption means may be a corresponding decryption key that can be transmitted to authorized devices.

Additional features and advantages of the present invention are described in, and will be apparent from, the description, figures, and claims herein.

### BRIEF DESCRIPTION OF THE DRAWINGS

Certain embodiments of the present invention will be described with reference to the following drawings, wherein:

FIG. 1 is a schematic architecture diagram illustrating an embodiment of a wirelessly networked IFE system;

FIG. 2 is a control flow diagram illustrating an embodiment of a process for establishing a communication link between a client device and a content server in the architecture illustrated in FIG. 1, wherein the client device is authenticated by a server;

FIG. 3 is a message flow diagram illustrating an embodiment of a message flow between processes for authentication and content streaming based on challenge and authentication;

FIG. 4 is a control flow diagram for a process for user selection of content in a client agent, wherein authentication is based upon a client device address value;

FIG. 5 is a control flow diagram for an embodiment of a process in a server for authorizing a client's content request, wherein authentication is based upon the client device address value;

FIG. 6 is a message flow diagram illustrating an example of the message flow between the processes of FIGS. 4 and 5;

FIG. 7 is a schematic architecture diagram illustrating an embodiment of a wireless IFE system wherein wireless client devices in communication with a server may include user supplied devices;

FIG. 8 is a message flow diagram illustrating an embodiment of a process wherein multiple content streams are broadcast via the wireless network of a wireless IFE and a user selects which stream to decode and display;

FIG. 9 is a protocol stack diagram illustrating a protocol stack for an embodiment of wireless connection between a content server and a client agent wherein a modified transport protocol layer is utilized to receive multiple broadcast streams; and

FIG. 10 is a protocol stack diagram illustrating a protocol stack for an embodiment of wireless connection between a content server and a client agent wherein a content stream is encrypted using a private/public key encryption scheme.

### DETAILED DESCRIPTION

IFE systems are generally described in commonly owned and assigned U.S. patent application Ser. No. 10/136,237, filed May 1, 2002, entitled Method and System for Configuration and Download in a Restricted Architecture Network, published as U.S. Publication No. 2003 0208579 A1, and U.S. patent application Ser. No. 10/145,464, filed May 14, 2002, entitled Method For Controlling An In-Flight Entertainment System, published as U.S. Publication No. 2003 0217363 A1, each of which is incorporated herein by reference in its entirety for purposes of disclosure.

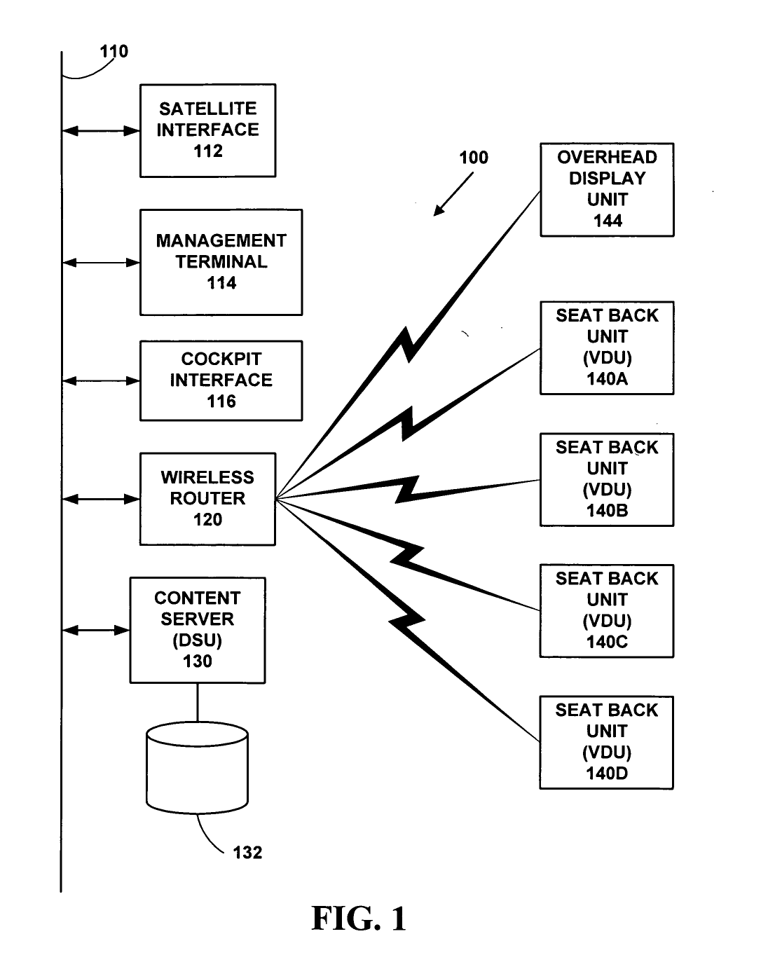

FIG. 1 is a diagram illustrating an embodiment of a reduced architecture IFE system 100. IFE system 100 includes a backbone network 110, such as a high speed local area network (LAN), to which are connected, in this example, a satellite interface 112 for transfer of content to and from a satellite, a management terminal 114 for control and administration of the IFE system 100, and a cockpit interface 116 for communications with the cockpit crew.

The IFE system further includes a digital server unit (DSU) 130 for distributing a variety of streaming audio/video offerings. Preferably, the server can support multiple clients and can broadcast multiple independent programs. Video content is typically stored on a storage unit (132), such as a disk drive of the DSU, in a compressed format, such as the Motion Picture Expert Group (MPEG) formats MPEG-1 and MPEG-2. Similarly, the audio content is typically stored in a compressed format, such as MPEG-3 (MP3). The storage unit is typically accessed using a high speed interface, such as a SCSI interface, which may be accessed by a technician in order to load content onto the storage unit. Multiple DSUs may be utilized in order to provide content to ADBs, tapping units, or other client devices.

According to an aspect of the invention, the IFE system 100 is wirelessly networked. For example, IFE system 100 also includes a wireless router 120 for wirelessly communicating with wireless client devices in the system, which include, in this example, seat back video display units (VDUs) 140A-D, and an overhead display unit 144. Preferably, a common wireless standard is used, such as IEEE 802.11a or IEEE 802.11g. In an embodiment, each of the VDU's 140A-D is mounted in the aircraft cabin for viewing by a passenger. For example, the VDU may be mounted in a seat back, facing rearwardly. Those skilled in the art will appreciate that the VDU can be mounted to any appropriate structure, such as arm rest, an overhead console or ceiling, or a bulkhead.

In an embodiment wherein a passenger can select from a variety of entertainment offerings to be displayed at the VDU, the VDU includes a passenger input device. The device may include, for example, a touch screen display or buttons located in a housing of the VDU, in an arm of the passenger seat, or some other convenient position.

In a preferred embodiment, IFE system distributes content in an on-demand manner as selected from a particular VDU. However, it will be understood that some or all of the content may be distributed in a broadcast manner, as will be described in further detail below. So that the operator of the IFE system can control services provided by the IFE system 100 of FIG. 1, it may be desirable to encrypt the content streams to the client devices. For example, encryption may be desirable in order to prevent reception and use of the content by unauthorized devices. This may be particularly important for providing copyright-protected content, such as movies. Also, in an embodiment, encryption may be desirable to implement a pay-per-view process that distributes content only to paying passengers.

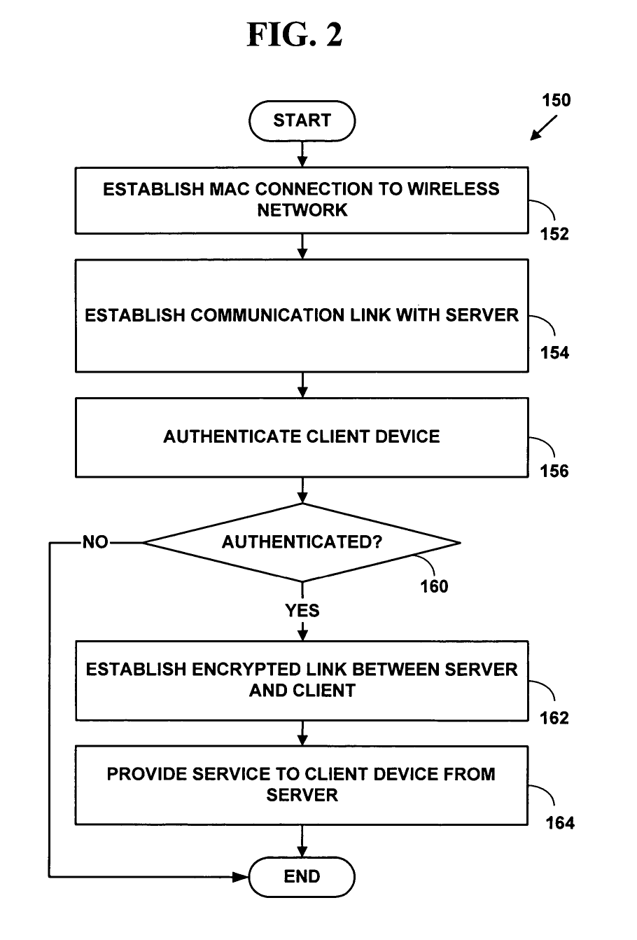

FIG. 2 is a control flow diagram illustrating an embodiment of a process 150 for establishing a communication link between a client device and a content server in the architecture illustrated in FIG. 1, wherein the client device is authenticated by a server. Each client device, such as VDUs 140A-D, establishes a media access control (MAC) connection to the wireless network provided by wireless router 120. In one example, a wireless card in each VDU communicates with the router. Following an established protocol, such as IEEE 802.11a or g, a communication link is established between the client device and a server, such as content server 130 in FIG. 1, at step 154. At step 156, the client device is authenticated by the server as a device authorized to receive content through IFE system 100. Several example of methods for authentication are discussed below.

If the client device is authenticated, then control branches at step 160 to step 162, where an encrypted link is established between the server and the client device. For example, content may be encrypted using a private key that can be decrypted using a public key provided to the client devices. This public key value may be purchased or authorized via the authentication process. Alternatively, an encrypted tunnel connection may be established between the client and server. Or content may only be provided to certain pre-authorized client address values. Examples are discussed further below. Once a link is established, service is provided to the client device and content is streamed from the content server 130, through wireless router 120 over the wireless IFE network to the client device.

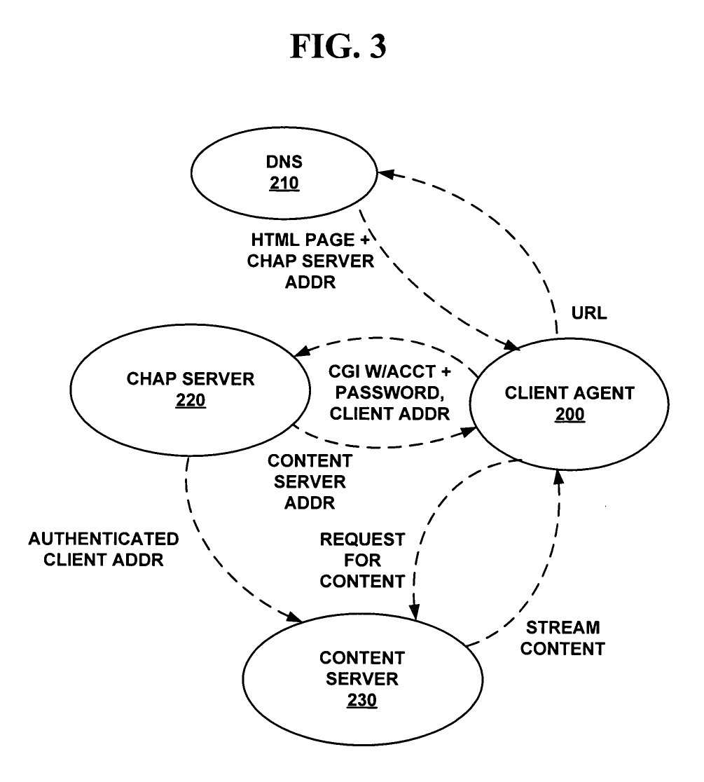

In one approach, a client agent process 200 (FIG. 3) in a client device, e.g. VDU 140A, is provided with a universal resource locator (URL) for an HTML page that is served to a user so that the user can provide information for a challenged handshake authentication protocol (CHAP). For example, the user may purchase services or provide authentication data indicating that user is authorized to receive services. Such authentication may be particularly useful in an embodiment wherein the client device is a portable device supplied by the user, rather than a dedicated device built into the aircraft. The HTML page alternatively may be used as a convenient interface for a maintenance technician to configure client devices for operation as part of the wireless IFE system 100, e.g. when the system is initialized or additional units are introduced.

FIG. 3 is a message flow diagram illustrating an embodiment of a message flow between processes for authentication and content streaming based on challenge and authentication using an HTML page. Client agent 200 transmits a request to the IFE system 100 with a URL value for the HTML page. The request is picked up by a domain name server (DNS) process 210, which, in this example, maps the URL value to the HTML page and serves the HTML page to client agent process 200 along with the CHAP server address value for CHAP server process 220. The HTML page, which is rendered and displayed to the user by the client agent, prompts the user for authentication information, such as an account and password, which results in a CGI request being sent to CHAP server process 220 along with the network address for the client device.

CHAP server process 220 checks the authentication information provided by the user to a database, for example, to authenticate the user and the client device. Note that some or all of the server processes discussed here may reside in the same machine or may be spread out over multiple machines, depending upon the demands on the IFE system 100. If the user provides valid authentication information, then CHAP server process 220 sends a message to content server process 230, which, in this example, resides in content server 130 of FIG. 1, indicating that a client device has been authenticated and providing the address of the client device on the network. CHAP server process 220 also provides the address of the content server process 230 to client agent process 200. Client agent 200 then sends a user's request for content to content server process 230 with the client device address. Content server process 230 checks the client device address against its list of authenticated client address values as provided by CHAP server process 220 and, since the client address value has been validated, streams the requested content to client agent process 200 at the client device address.

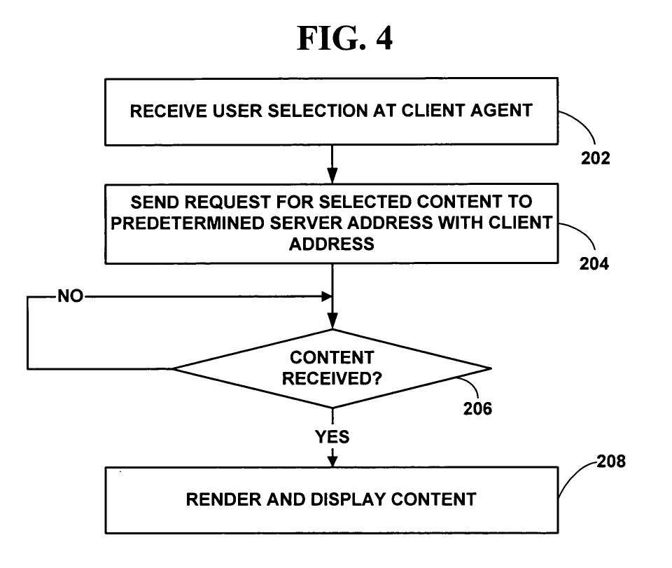

Turning to FIG. 4, a control flow diagram is illustrated for a process for user selection of content in a client agent where authentication is based upon a client device address value. At step 202, the client agent receives a user selection. Note that, at various points in the authentication process discussed above, the client agent may be supplied with an HTML page that provides the user with a selection of options for content to choose from or a separate step may be provided for obtaining data for the user's available choices. At step 204, the user's selection causes a request to be sent for the selected content to the content server process address provided above, where the request message includes the client device address. The agent process then waits at step 206 to receive the requested content, which is rendered and displayed to the user at step 208 when it is received. For example, audio or video content may be served to the user in this manner.

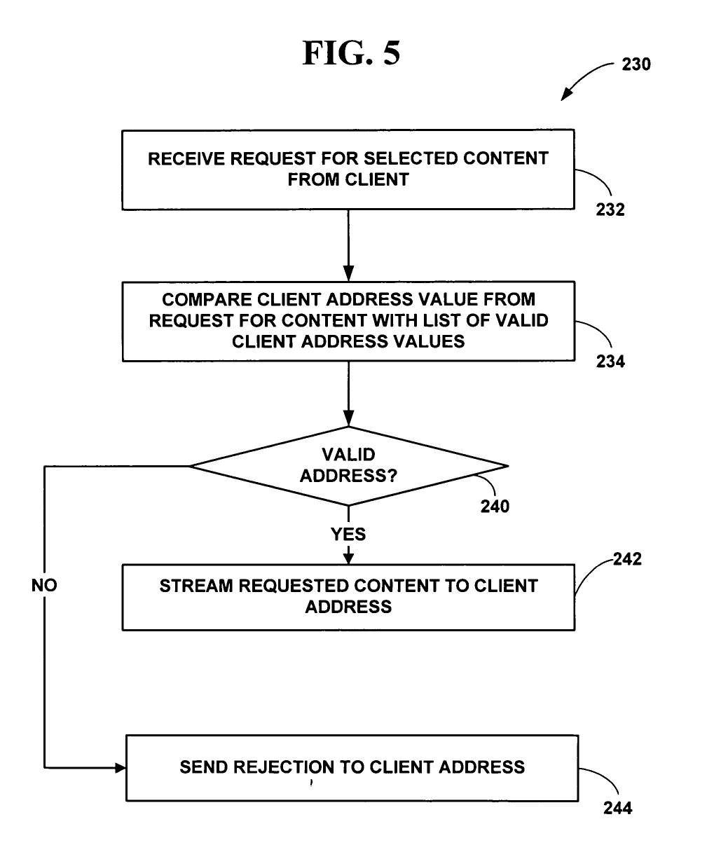

The request sent by the client agent in FIG. 4 is processed by a content server process. FIG. 5 is a control flow diagram for an embodiment of content server process 230 in a server where authentication is based upon the client device address value. At step 232, the server process receives the request for selected content from the client agent. At step 234, the server process compares the client address value from the request for content with the list of valid client address values compiled on the basis of messages from CHAP server process 220. If the address value is valid, then control flow branches at step 240 to step 242 where the content requested by the user is streamed to the client address via the wireless connection to the client device. If the address value is not one of the validated addresses provided to the content server process 230, then, in this example, a rejection message is sent to the client address. The rejection message may include the CHAP HTML page in order to reinitiate the authentication process.

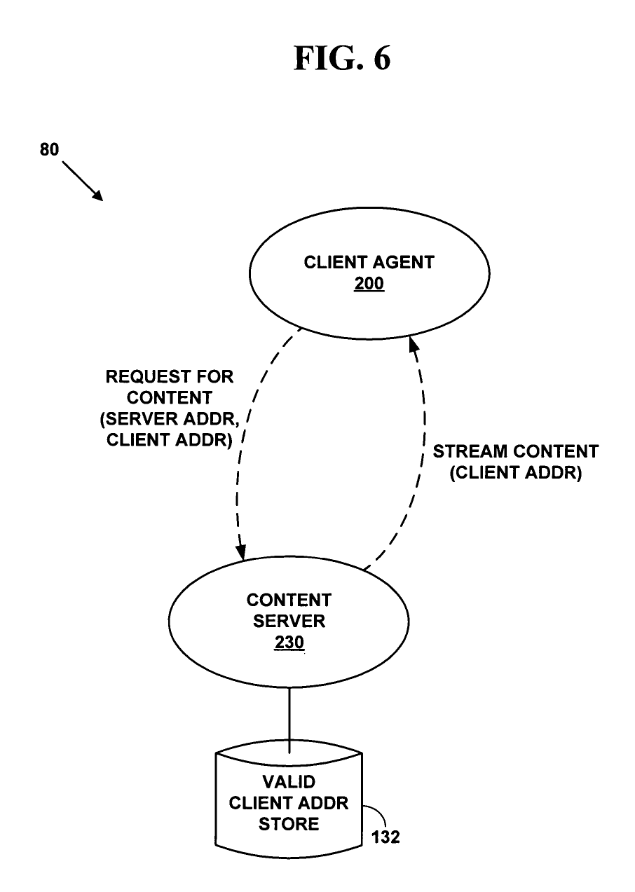

FIG. 6 is a message flow diagram illustrating an example of the message flow between the processes of FIGS. 4 and 5. The client agent 200 sends requests for content to the content server process 230. Content server process 230 validates the address from information in storage 132, e.g. a hard drive, retrieves the requested client from storage 132, and streams the content to client agent 200 through wireless router 120 over a wireless connection to the address of the client device, e.g. VDUs 140A-D, to the client agent.

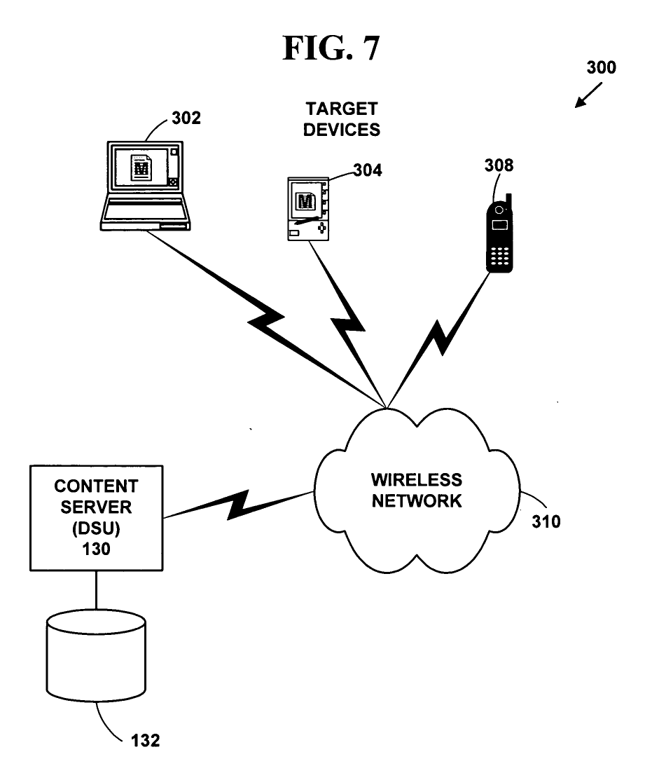

As noted above, the client devices may be VDUs or other devices that are provided with the IFE system 100. In this case, the CHAP process may take the form of a maintenance routine whereby an IFE system technician enters and validates each of the client devices that are part of the IFE system and the system is thereby configured for operation. Alternatively, the client device may be provided by the user. FIG. 7 is an architecture diagram illustrating an embodiment of a wireless IFE system 300 wherein wireless client devices in communication with a server may include user supplied devices. For example, the user may have a wireless enabled device capable of receiving content for the user, such as a portable personal computer 302, a personal data appliance (PDA) 304, or a mobile telephone 308. In this case, wireless router 130 of FIG. 1 is configured to establish a communication link with these user provided client devices. As noted above, the CHAP process may involve authorizing the client device on the basis of payment made by the user, in which case the CHAP process includes an interface for collecting the necessary billing information. Alternatively, the authentication information (e.g. an account and password or a public key for use in decrypting data streams) may be purchased from a flight attendant or other secure means.

Broadcast message streams may be preferred in certain applications for providing content. For example, streaming broadcast content may be preferred for IFE systems that do not have sufficient capacity to provide a custom data stream for each user. In this approach, each data stream may be simultaneously broadcast. For example, packets are transmitted in the system using a broadcast address provided by an appropriate protocol, such as transport control protocol (TCP), with the different streams being differentiated from one another by unique socket values. Alternatively, multiple broadcast addresses may be provided by a transport layer protocol with each stream corresponding to one broadcast address.

It should be noted that for transmitting data that is not specific to an individual seat connection (e.g., PA, Overhead video audio) or in an area of the aircraft where VDU's are mounted for shared viewing among multiple passengers, it is preferable to distribute the data using a streaming network protocol that does not perform error checking, such as Real-Time Protocol (RTP), rather than a guaranteed delivery protocol such as TCP/IP. Streaming protocols that support broadcast services (like RTP) do not detect errors and do not perform retransmissions. Decoding such a signal, therefore, allows for more synchronous transmission. Erroneous portions are merely dropped.

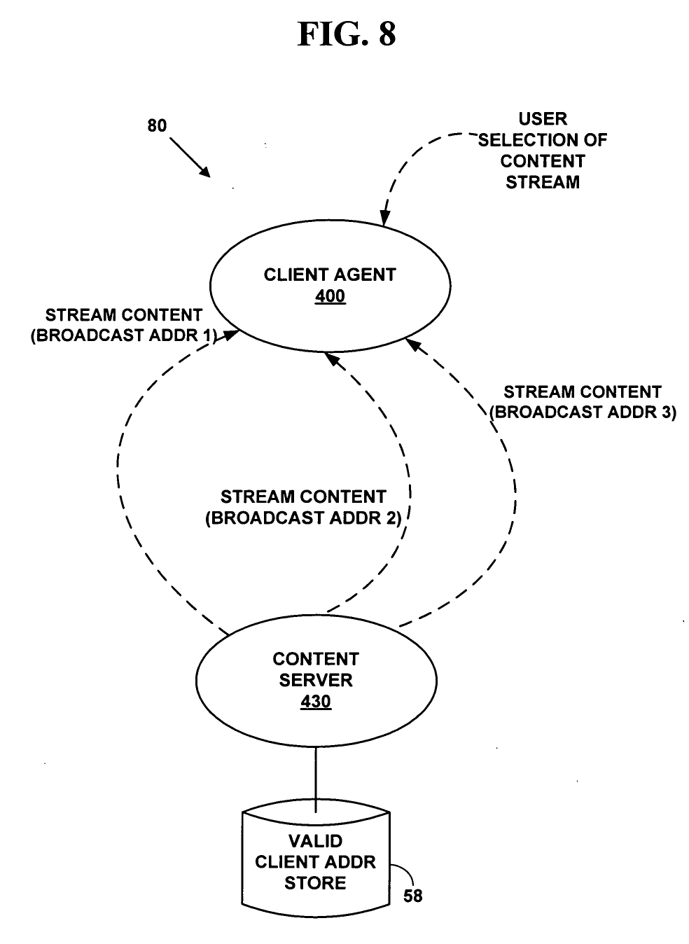

FIG. 8 is a message flow diagram illustrating an embodiment of a scheme wherein multiple content streams are broadcast via the wireless network of a wireless IFE and a user selects which stream to decode and display. A client agent process 400 is configured to receive multiple broadcast content streams transmitted by a content server process 430 that is configured to transmit packets for each content stream. For example, three different video programs may be transmitted as a stream of broadcast packets with different socket or broadcast address values, incidated in FIG. 8 as broadcast addresses 1, 2 and 3.

A user selection received by the client agent 400 determines which of the broadcast content data streams is to be buffered and displayed to the user. For example, if the user selects video program 1, client agent 400 buffers the broadcast packets it receives for broadcast address 1, or socket 1 depending upon the implementation, and renders those packets for display. The packets for all other broadcast streams are discarded.

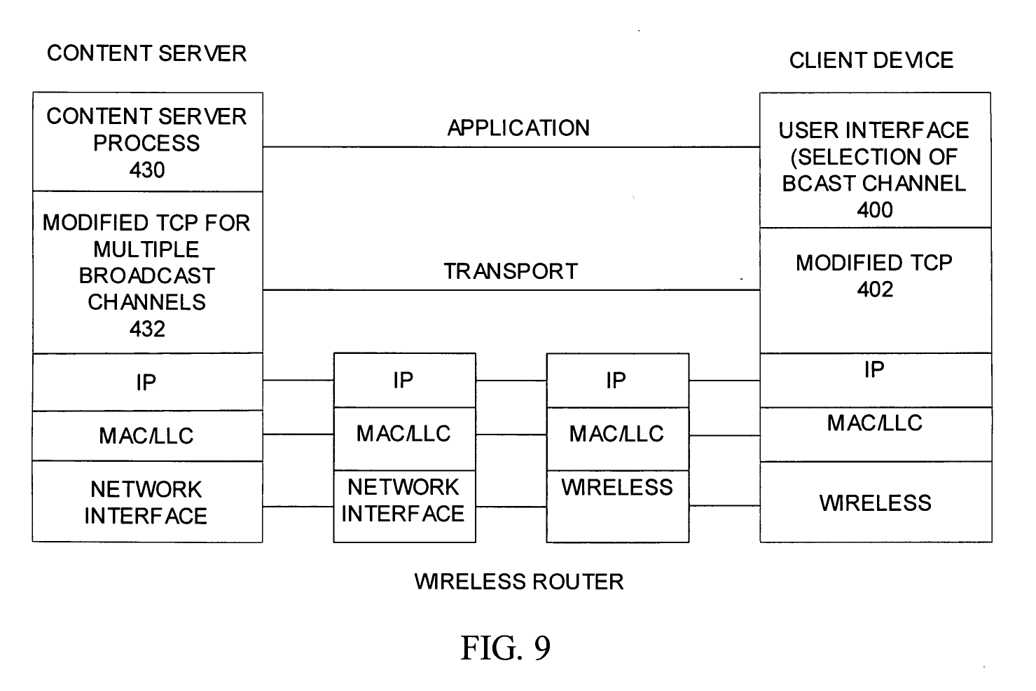

FIG. 9 is a protocol stack diagram illustrating a protocol stack for an embodiment of wireless connection between a content server and a client agent wherein a modified transport protocol layer, e.g. a modified TCP scheme, is utilized to receive multiple broadcast streams. In this scheme, a content server containing the content server process 430 is in wireless communication with a client device, e.g. a user supplied device or a device that is a dedicated part of the IFE system, that contains client agent process 400. In this example, the protocol stack illustrates a network interface, MAC or link level control (LLC), and internet protocol (IP) relation at the physical, link and network levels, respectively, between content server 130 and wireless router 120. Wireless router 120 also has a wireless interface, MAC/LLC, IP relation at the physical, link and network levels, respectively, with the client device. In this example, the content server process 430 uses a modified TCP layer 432 to transmit each content data stream as packets having either a different broadcast address or using the standard broadcast address in combination with different socket values. A modified TCP layer 402 in the client device monitors the broadcast packets transmitted by content server process 430 and buffers and passes up to the client agent 400 only those broadcast packets corresponding to the stream selected by the user. The broadcast packets for the selected stream are then rendered and displayed for the user.

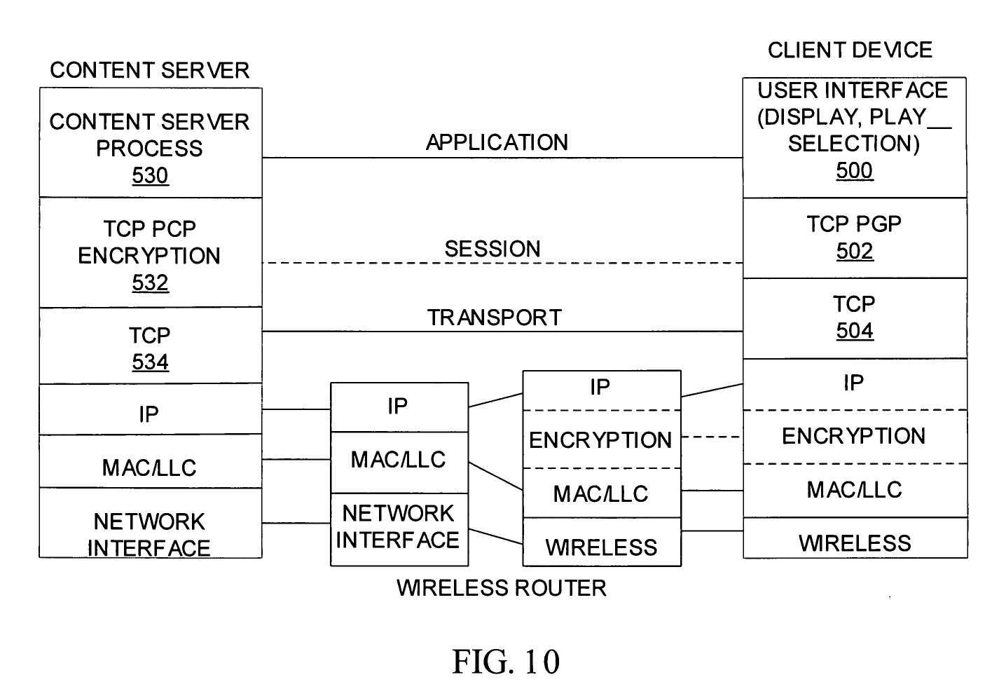

Encryption of content data streams, such as individualized content streams unique to each user or broadcast streams, to prevent unauthorized access was noted above. FIG. 10 is a protocol stack diagram illustrating a protocol stack for an embodiment of wireless connection between a content server and a client agent wherein a content stream is encrypted using a private/public key encryption scheme. Other encryption schemes may also be applied, such as dedicated keys preconfigured in the content server and client devices by maintenance or installation personnel. Two variations are shown in FIG. 10 where a public/private key encryption scheme is utilized, which, in this example, is pretty good protection (PGP). In one approach, PGP runs at the session layer 532 above the transport layer 534 on the server side and at session layer 502 above transport layer 504 on the client side. In another approach, PGP is a service of the transport layer. In both cases, content data at the content server is encrypted using a private key and transmitted to the client device where it is decrypted using a public key provided to the user by a flight attendant, for example. As a further alternative, an encryption/decryption process can be implemented in data communicated between the router and client device running in a layer below the IP layer at the client device and router, as illustrated in FIG. 10. Such encryption/decryption can be in accordance with IEEE 802.11i. Other encryption schemes may be utilized.

Aircraft passengers commonly travel with individual personal computers that are equipped with wireless networking interfaces. These wireless interfaces are typically used in land-based environments to communicate with a server over high-frequency RF signals. The presence of these laptops or other portable wireless communication devices within the environment of the present IFE system presents potential for the IFE wireless signal to be received by devices other than the IFE displays. On the one hand, an operator of the IFE system may want to prevent the content of the wireless IFE signal to be playable by portable wireless communication devices, permitting the signal to be properly played only by the IFE displays. On the other hand, an operator of the IFE system may want to facilitate the reception and playing of the IFE content on the portable wireless devices, but in a controlled manner whereby a pay-per-view fee can be charged and/or unauthorized copying of the signal content can be prevented. Control over playability of the signal is important, for example, when the video offering is a copyright protected work, such as most movies.

In addition to entertainment, the IFE system is useful for other critical cabin functions such as for public address (PA) announcements. The PA function enables crew members to broadcast audio announcements to all passengers in the aircraft. The IFE permits such announcements to be heard without interference. Preferably, the IFE ceases transmission of audio relating to entertainment presentations and instead transmits the PA announcement instead to the headsets. Alternatively, the IFE could cease the transmission of audio relating to entertainment presentations, resulting in no headphone output so that the passengers can hear the PA announcement over the ambient speakers. This means that silence at the headset is certifiable but customer expectations are that the PA audio will be presented to the passenger headset as well. All other entertainment transmissions cease upon transmission of the selected entertainment presentation.

Area passenger announcements are PA announcements that are restricted to a specific area of the aircraft (like first class, economy, crew rest, etc.). Seats in the corresponding area should meet the requirements for PA (silence or presentation of the PA speaker audio). During an area PA, entertainment signals must continue delivery to seats that are not in the designated area in order to operate unaffected. The area passenger announcements preferably have are delivered to the headset with a delay of no more than about 35 ms delay from input into system. The PA area may cover multiple wireless areas. A wireless area may be able to cover multiple PA areas. Entertainment should continue during announcement.

In an IFE system having at least some overhead video displays (displays arranged to be viewed by multiple passengers), the same image is presented to each of the overhead displays in a specified area. The presentation is preferably synchronized to within about 60 ms across all displays. The audio associated with an overhead video program is presented to each passenger wanting to watch the overhead video program. The audio associated with the overhead video program must also be presented to the passenger's ear within about the same 60 ms. In an embodiment, uncompressed digital audio is delivered to the seat for the one overhead video program in the area. Overhead may be provided with analog/ARINC722 standard interface to avoid overhead display synchronization issues.

The IFE system may be configured to present a video announcement (VA) as an overhead video program having associated audio that is played over the PA system as an area PA. In an embodiment, the IFE system operates with a video override feature that, when activated, forces all in-seat video displays in the designated Overhead Video area to ON and presents a single specific video program in each of these displays.

In an embodiment, the wireless activity is ceased during critical flight phases if deemed necessary to avoid interference with aircraft communication equipment or navigation instruments. In an embodiment where the display units wirelessly communicate passenger service system (PSS) selections, the PSS functions would be unavailable during such critical flight phases.

In an embodiment, a database is provided to establish parameters for the features of area PA, video announcements, class oriented features, and PSS on a seat-by-seat basis. The database may be distributed to the seats (e.g. as part of maintenance activity) to ensure that time critical responses (like PSS and area PA) can be met.

It can thus be seen that a new and useful wirelessly networked IFE system has been described. Note that there are many possible variations of the embodiments described herein that fall within the scope of the following claims. Additionally, every implementation and configuration described herein is meant to be an example only and should not be taken as limiting the scope of the claims. Also, note that the use of the terms “a” and “an” and “the” and similar referents in the context of describing the invention (especially in the context of the following claims) are to be construed to cover both the singular and the plural. Furthermore, recitation of ranges of values herein are merely intended to serve as a shorthand method of referring individually to each separate value falling within the range, unless otherwise indicated herein, and each separate value is incorporated into the specification as if it were individually recited herein. Finally, the steps of all methods described herein can be performed in any suitable order unless otherwise indicated herein or otherwise clearly contradicted by context.

1. A system for providing multimedia content to a passenger on an aircraft, the system comprising: a local area network; a content server for distributing multimedia content over the local area network; a wireless router for communicating wirelessly with network clients; and a video display unit client device adapted to communicate with the local area network through the wireless router, the video display unit mounted in a position viewable from a seat of the aircraft passenger.

2. The system of claim 1, wherein the video display unit is assigned a network address and adapted to send a request for content selected by the passenger, wherein a server receives the request and permits distribution of the selected content to the network address corresponding to the video display unit.

3. The system of claim 2, wherein said server compares the network address of the video display unit to a list of valid client address values and permits distribution only if the network address matches a valid address value on the list.

4. The system of claim 1, further comprising an authentication server that assigns an encryption key to the video display unit and to the content server, the content server distributing the selected content to the network address corresponding to the video display unit only if the encryption key has been assigned to both the content server and the video display unit.

5. The system of claim 1 comprising a plurality of video display units, wherein the content server broadcasts public address messages to the video display units.

6. The system of claim 1 comprising a plurality of video display units, wherein the content server broadcasts a plurality of entertainment offerings to the video display units over a plurality of respective broadcast addresses, each of the video display units adapted to select one of the broadcast addresses and display the corresponding entertainment offering.

7. The system of claim 1, further comprising at least one portable client device, wherein the client device can communicate wirelessly with the network through the wireless router to receive multimedia content.

8. An IFE system for providing multimedia content to passengers aboard an aircraft, the system comprising: a local area network aboard an aircraft; means for distributing multimedia content over the local area network; a video display means for displaying multimedia content to at least one aircraft passenger; and means for wirelessly communicating between the local area network and network clients.

9. The system of claim 8, wherein the video display unit is assigned a network address and adapted to send a request for content selected by the passenger, the system further comprising means for distributing of the selected content to the network address corresponding to the video display means.

10. The system of claim 9, further comprising means for comparing the network address of the video display means to a list of valid client address values, wherein distribution to the client address is permitted only if the network address matches a valid address value on the list.

11. The system of claim 8, further comprising means for assigning an encryption key to the video display means and to the means for distributing multimedia content, and means for distributing the selected content to the network address corresponding to the video display unit only if the encryption key has been assigned to both the content server and the video display unit.

12. The system of claim 8 comprising a plurality of video display means, wherein the means for distributing content includes means for broadcasting public address messages to the plurality of video display means.

13. The system of claim 8 comprising a plurality of video display means, wherein the means for distributing multimedia content broadcasts a plurality of entertainment offerings over the network over a plurality of respective broadcast addresses, further comprising means for selecting one of the broadcast addresses for display at each of the respective video display means.

14. A process for wirelessly distributing multimedia content to video display units aboard an aircraft, the process comprising: providing a wireless local area network; providing a client video display device equipped to communicate with the network through a wireless router; establishing a MAC connection of the video display device to the wireless network; and delivering a stream of video data from a content server to video display device over the MAC connection.

15. The process of claim 14, further comprising comparing an address of the video display unit to a list of valid client address values; whereby the delivery step is performed as a condition of a match of the network address to a valid address value on the list.

16. The process of claim 14, further comprising: submitting a request from the video display unit; and assigning an encryption key to the video display unit and to a content server; whereby the delivering step is performed as a condition of assignment of the encryption key to both the content server and the video display unit.

17. The process of claim 14 whereby the delivery step includes broadcasting at least one stream of video data to a plurality of the video display units.

18. The process of claim 17, further comprising assigning a broadcast address to each of a plurality of broadcast streams; selecting one of the broadcast streams at the video display unit from a selected one of the broadcast addresses; displaying the selected broadcast stream on the video display unit.
